(19) United States
(12) Patent Application Publication
(10) Pub. No.: US 2026/0024928 A1
(43) Pub. Date: Jan. 22, 2026

(54) SET COMPRISING A PLURALITY OF ADAPTER PLATES, ADAPTER PLATE OF SUCH A SET, AND CONDUCTOR TERMINAL BLOCK

(71) Applicant: WAGO Verwaltungsgesellschaft mbH, Minden (DE)

(72) Inventors: Rudolf MASTEL, Minden (DE); Parth PANCHAL, Kosamba, Surat (IN)

(73) Assignee: WAGO Verwaltungsgesellschaft mbH, Minden (DE)

(21) Appl. No.: 19/273,049

(22) Filed: Jul. 17, 2025

(30) Foreign Application Priority Data
Jul. 19, 2024 (DE) 20 2024 104 041.4

(51) Int. Cl. H01R 9/24

(52) U.S. Cl. CPC H01R 9/2466

(57) ABSTRACT

A set is provided that includes a plurality of adapter plates for connecting conductor terminals of different sizes. An adapter plate of such a set and a conductor terminal block which is modularly constructed from individual conductor terminals and adapter plates of such a set, are also provided.

This nonprovisional application claims priority under 35 U.S.C. § 119(a) to German Patent Application No. 20 2024 104 041.4 which was filed in Germany on Jul. 19, 2024, and which is herein incorporated by reference.

### BACKGROUND OF THE INVENTION

### Field of the Invention

The invention relates to a set comprising a plurality of adapter plates for connecting conductor terminals of different sizes. The invention furthermore relates to an adapter plate of such a set and to a conductor terminal block which is modularly constructed from individual conductor terminals and adapter plates of such a set.

### Description of the Background Art

Conductor terminals are used to connect the respective electrical conductors, e.g., by spring-loaded clamping. Such conductor terminals with spring-loaded clamping connections are known in a wide variety of designs, wherein conductor terminals are offered in different sizes depending on the conductor cross section of the electrical conductor to be connected. Conductor terminals can, e.g., be designed as multipole conductor terminals in which a number of spring-loaded clamping connections are arranged in one housing and accordingly a number of electrical conductors can be connected to them. Conductor terminals can also have a disk-like design, in which an individual conductor terminal has only one spring-loaded clamping connection and is accordingly only designed to receive one electrical conductor. Such disk-like conductor terminals can be snapped together laterally with their housings in order to form a multipole conductor terminal block. However, only conductor terminals of the same size can be snapped together.

### SUMMARY OF THE INVENTION

It is therefore an object of the invention of expanding the possibilities for creating a conductor terminal block from individual conductor terminals.

This object is achieved, in an example, by a set comprising a plurality of adapter plates for connecting conductor terminals of different sizes, wherein each adapter plate has a plate-shaped base body with a first connection side and a second connection side facing away from the first connection side, wherein on the first connection side the base body has first connecting elements, which are configured to be connected to connecting elements of a conductor terminal, the elements being designed as counterparts to the first connecting elements, wherein on the second connection side the base body has second connecting elements, which are configured to be connected to second connecting elements of an adjacent adapter plate, the elements being designed as counterparts, wherein the set has adapter plates with base bodies of different sizes, wherein the size of the base body is adapted in each case to the size of a conductor terminal to be connected to the first connection side of the adapter plate. Because any adapter plates in the set, even if they have base bodies of different sizes, can always be connected to one another on their respective second connection sides via the second connecting elements, the user can assemble a conductor terminal block according to his requirements from conductor terminal blocks of different sizes using the plug-in module principle. The adapter plates in the set all have an identical distribution pattern of the second connecting elements on their second connection sides, so that any adapter plates are compatible with each other.

A universal adapter plate configuration for connecting conductor terminals of different sizes can be provided in this way.

Two conductor terminals of different sizes, which are connected to one another via such adapter plates of the set, are then typically connected to one another via a first adapter plate, which is associated in terms of size with a conductor terminal of a first size, and a second adapter plate, which is associated in terms of size with a conductor terminal of a second size, so that two adapter plates are always connected to one another at the interface of adjacent conductor terminals. In principle, the adapter plates can be used to realize any size jumps between adjacent conductor terminals.

The adapter plates with differently sized base bodies may each have connection-compatible second connecting elements on their second connection sides, so that conductor terminals of different sizes can be connected to one another via adapter plates with differently sized base bodies, in that the conductor terminals of different sizes are connected to one another via the second connecting elements on the second connection sides of adjacent adapter plates.

The conductor terminals can each have their own housing. In this case, the adapter plate is connected with its first connection side and the first connecting elements to the corresponding connection components on the housing of the conductor terminal. The conductor terminals can be formed, e.g., as PCB terminals.

Such conductor terminals usually have a conductor insertion side with a conductor insertion opening where the electrical conductor can be inserted into the housing of the conductor terminal. When looking at the conductor terminal on the conductor insertion side, the left housing side is to the left of the conductor insertion side and the right housing side is to the right of the conductor insertion side. The terms left and right are used in this sense.

The set for the conductor terminals of different sizes can each have a left-sided adapter plate, which can be connected with its first connection side to a left housing side of the conductor terminal, and a right-sided adapter plate, which can be connected with its first connection side to the right housing side of the conductor terminal. Accordingly, there is a left-sided and a right-sided adapter plate in the set for each size, so that conductor terminals of different sizes can be connected to one another left/right in both directions.

The first connecting elements and/or the second connecting elements can be designed as positive-locking connecting elements, in particular as latching elements. This allows easy plugging together of the conductor terminals with the adapter plates or the adapter plate to one another with simultaneous good holding of the individual components together.

The adapter plates of the set can be configured to connect the conductor terminals to one another in identical spatial alignment of their conductor connection side. The conductor insertion openings of a conductor terminal block formed by means of the adapter plates are then all accessible from the same side.

The aforementioned object is also achieved by an adapter plate of a set of the type described above, wherein the adapter plate can have a plate-shaped base body with a first connection side and a second connection side facing away from the first connection side, wherein on the first connection side the base body has first connecting elements, which are configured to be connected to connecting elements of a conductor terminal, the elements being designed as counterparts to the first connecting elements, wherein on the second connection side the base body has second connecting elements, which are configured to be connected to second connecting elements of an adjacent adapter plate, the elements being designed as counterparts. The previously described advantages can also be realized in this way.

The aforementioned object is also achieved by a conductor terminal block which is modularly constructed from individual terminals and adapter plates of a set of the type described above, having conductor terminals of different sizes, wherein a first adapter plate is connected with its first connection side to at least one conductor terminal of a first size and a second adapter plate is connected with its first connection side to at least one adjacent conductor terminal of a second size, which differs from the first size, wherein the first and second adapter plates are connected to one another via their respective second connection sides. The previously described advantages can also be realized in this way. The conductor terminal block can also be composed of conductor terminals with more than two different sizes, e.g., with three or four different sizes.

Advantageously, the conductor connection sides of all conductor terminals in the conductor terminal block can be aligned in the same spatial direction.

According to an example of the invention, it is provided that a plurality of conductor terminals of the same size are connected directly immediately adjacent to one another without an adapter plate being arranged therebetween. This allows a particularly compact design of the conductor terminal block and material savings. Adapter plates accordingly only need to be used between conductor terminals of different sizes. Nevertheless, it is certainly possible in individual cases to connect conductor terminals of the same size with one another via two adapter plates plugged together.

At least one conductor terminal can have a housing which has an open housing side on one side, wherein the open housing side is covered by an end plate attached to the housing or an adapter plate. With such a housing open on one side, the conductor terminal can be realized in a relatively slim design, which results in the saving of space and material, especially when a large number of conductor terminals of the same size are connected together. In this regard, the open housing side of a conductor terminal is closed in each case by the housing of an adjacent conductor terminal. Only in the last conductor terminal block in this series does its housing need to be then covered by an end plate or adapter plate.

The end plate can differ from the adapter plate in that it does not have a second connection side with second connecting elements. On a side corresponding to the second connection side, the end plate can instead have connecting components which are compatible with the first connecting elements on the first connection side of an adapter plate. The end plate can differ further from the adapter plate in that the end plate has a base body with a smaller material thickness than the adapter plate.

An adapter plate can be attached with its first connection side to the end plate. In this way, the additional end plate can be integrated into the structure of the conductor terminal block.

For example, the first connecting elements can be designed as pins projecting from the base body (e.g., latching pins) or as hole-like pin receptacles (e.g., latching recess) in the base body. The second connecting elements can be designed as pins projecting from the base body or as hole-like pin receptacles in the base body.

A left-sided adapter plate can have second connecting elements which are designed as counterparts to the second connecting elements of any right-sided adapter plate. For example, the second connecting elements of a left-sided adapter plate can be designed as latching pins, and the second connecting elements of the right-sided adapter plate can be designed as latching recesses corresponding to the latching pins. Of course, a reverse matching is also possible, or a mixed configuration in which the second connecting elements of the left-sided adapter plate and the right-sided adapter plate are formed by a mixture of latching pins and latching recesses.

The technical advantages that can be achieved by the invention include:

Space saving: The universal adapter system reduces the need for multiple adapters and additional components, saves space, and simplifies the assembly process.

Increased compatibility: The versatile design of the invention is suitable for a wide range of conductor terminal sizes, orientations, and types, which improves compatibility and reduces the need for customized solutions. A wide variety of conductor terminal blocks can be created thereby.

Flexibility and adaptability: The adjustable patch spacing of the invention and the ability to connect together differently sized conductor terminals side by side offer greater flexibility and adaptability to different PCB layouts and configurations.

Simplified assembly: The numerous adapters with first connecting elements, e.g., snap-in pins, for each conductor terminal, which are tailored to their size, orientation, and type, simplify the assembly process, reduce the risk of errors, and improve overall user-friendliness.

Improved reliability: The unique features of the invention, such as, e.g., separate adapters for different types of terminal strips and adjustable spacing with spacers, contribute to a safer and more reliable connection and reduce the risk of connection errors and maintenance problems.

Versatile double-sided adapters: Each conductor terminal can be equipped with two adapters which can be mounted both on the left or right side. These adapters have a unique design that enables them to connect seamlessly to adjacent terminal blocks of different sizes, suitable for left and right connections.

Overall, the technical advantages of the invention contribute to a more efficient, reliable, and cost-effective solution for connecting conductor terminals and in particular PCB terminal blocks and improve compatibility, versatility, and user-friendliness for users working with conductor terminals of different sizes, orientations, and types.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a set of multiple adapter plates;

FIG. 2 shows a conductor terminal and two adapter plates in a first view;

FIG. 3 shows the conductor terminal with the adapter plates according to FIG. 2 in a second view;

FIG. 4 shows a conductor terminal block in an example;

FIG. 5 shows a conductor terminal block in an example; and

FIG. 6 shows a conductor terminal block in an example.

### DETAILED DESCRIPTION

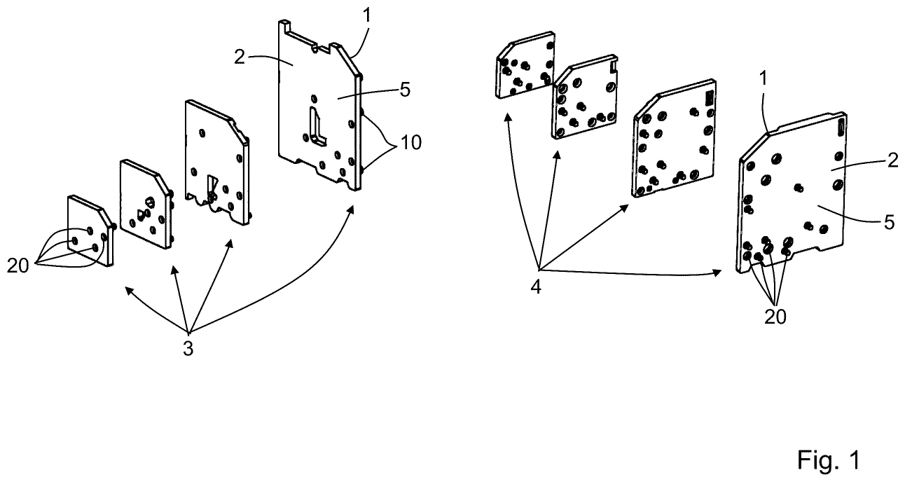

FIG. 1 shows a set of adapter plates 3, 4, which comprises left-sided adapter plates 3 and right-sided adapter plates 4. Adapter plates 3, 4 each have a plate-shaped base body 5, wherein in the case of left-sided adapter plates 3 and right-sided adapter plates 4, base bodies 5 each have four different sizes so that they can be attached to conductor terminals of four different sizes.

Each adapter plate 3, 4 has a first connection side 1 on base body 5 and a second connection side 2 facing away from first connection side 1. Base body 5 has first connecting elements 10 on first connection side 1 and second connecting elements 20 on second connection side 2. First connecting elements 10 are each designed as counterparts to connecting components on the housings of the conductor terminals. Second connecting elements 20 of left-sided adapter plates 3 are designed as counterparts to second connecting elements 20 of right-sided adapter plates 4, so that in each case a left-sided adapter plate 3 can be plugged together at its second connection side 2 with second connection side 2 of a right-sided adapter plate 4.

In this regard, left-sided adapter plates 3 of different sizes each have second connecting elements 20 which are connection-compatible with second connecting elements 20 of right-sided adapter plates 4 of any size; i.e., irrespective of the size of base body 5, second connecting elements 20 are each attached at the same positions relative to one another and relative to a reference position of base body 5, e.g., always at the front bottom corner facing the conductor insertion side.

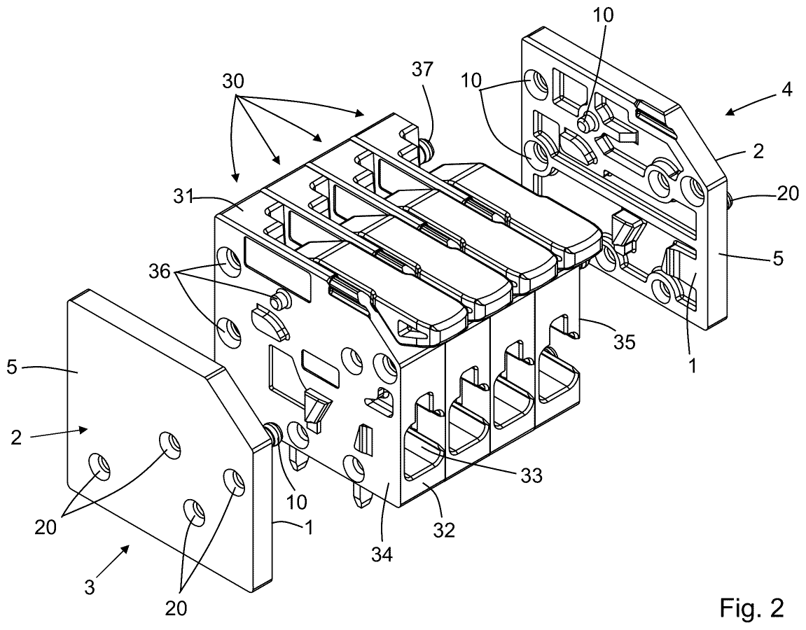

FIG. 2 shows four conductor terminals 30 plugged together to form a conductor terminal block. Conductor terminals 30 each have a disk-like housing 31, on the left housing side 34 of which there are connection components 36 for plugging together and on the right housing side 35 of which connection components 37 are disposed that are connection-compatible with left-sided connection components 36. Conductor terminals 30 each have a conductor insertion opening 33 on one conductor insertion side 32, through which an electrical conductor can be inserted into housing 31. The designations “left housing side” and “right housing side” refer to a viewing direction of the conductor terminal that is directed towards conductor insertion side 32. Then the left housing side 34 is on the left and the right housing side 35 is on the right.

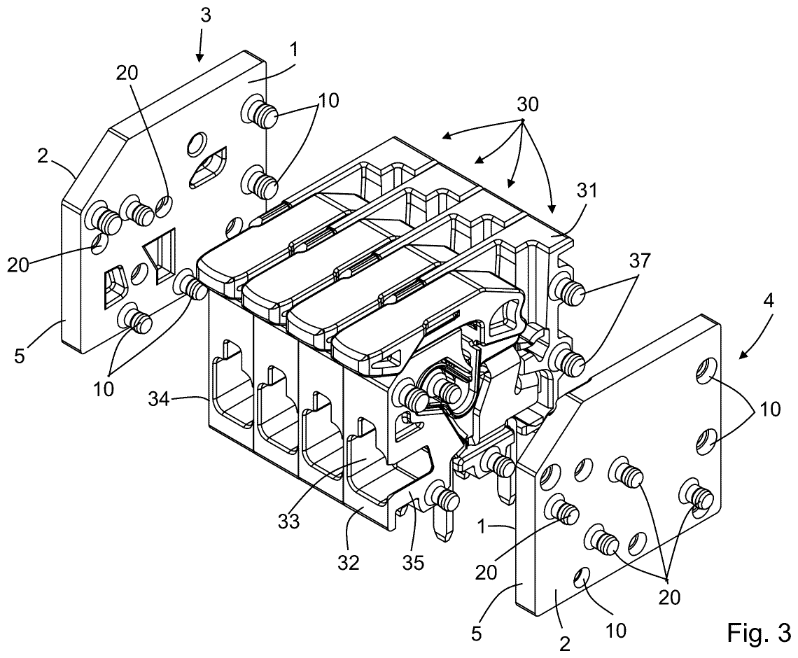

FIG. 2 shows conductor terminals 30 each viewed in a direction towards left housing side 34. FIG. 3 shows the same arrangement as FIG. 2, in a viewing direction towards right housing side 35.

As can be seen, a left-sided adapter plate 3 can be attached with its first connection side 1 to left housing side 34. A right-sided adapter plate 4 can be attached with its first connection side 1 to right housing side 35.

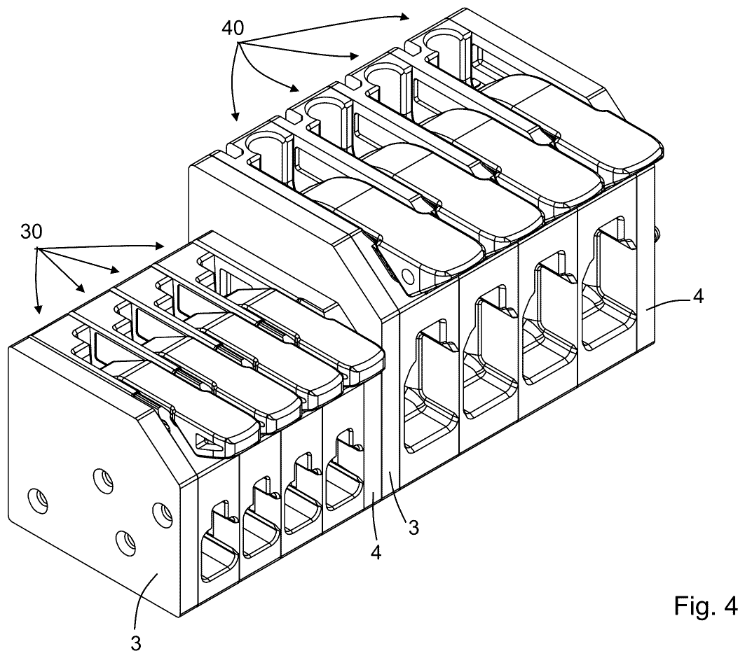

FIG. 4 shows the assembly of conductor terminals 30 of the size, as has been explained in FIGS. 2 and 3, with conductor terminals 40 of a larger size to form a conductor terminal block. Conductor terminals 30 of the smaller size, which are plugged together, are closed on the left side with a left-sided adapter plate 3 and on the right side with a right-sided adapter plate 4. In a similar way, multiple conductor terminals 40 of the larger size are plugged together and this plugged-together block is covered on the left side by a left-sided adapter plate 3, selected to match the size, and on the right side by a right-sided adapter plate 4. These two sub blocks of conductor terminals 30, 40 are connected to one another via right-sided adapter plate 4 of conductor terminals 30 and left-sided adapter plate 3 of conductor terminals 40, wherein adapter plates 3, 4, which have different sizes at this connection point, are connected to one another via their respective second connection sides 2 and second connecting elements 20.

As can be seen, the adapter plates can be designed in such a way that conductor terminals 30, 40 of different sizes are assembled on conductor insertion side 32 in alignment with one another, i.e., without offset, to form a conductor terminal block. In addition, the arrangement of conductor terminals 30, 40 can be aligned on the underside of the housing; i.e., there is no offset on the underside of the housing.

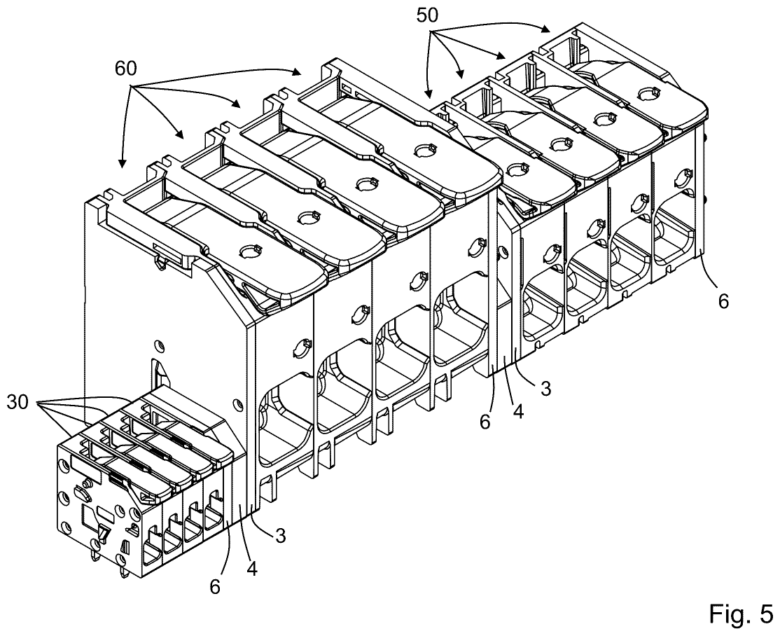

FIG. 5 shows a conductor terminal block formed with adapter plates 3, 4 of the invention from conductor terminals 30 of a small size, as described with reference to FIGS. 2 and 3, with conductor terminals 60 of a fourth size attached adjacent thereto and conductor terminals 50 of a third size attached thereto in turn. In this case, the fourth size is larger than the third size, and the third size is larger than the first size. Conductor terminals 30, 50, 60 of different sizes can in turn be connected to one another by two directly adjacent adapter plates 3, 4 which are plugged together.

FIG. 5 shows an example in which conductor terminals 30, 60, 50, which are plugged together, are covered by an additional end plate 6 on right housing side 35 of the last conductor connection terminal, i.e., the housing side that thus remains open. A right-sided adapter plate 4 is then placed on end plate 6, which is then connected to a left-sided adapter plate 3 of a different size.

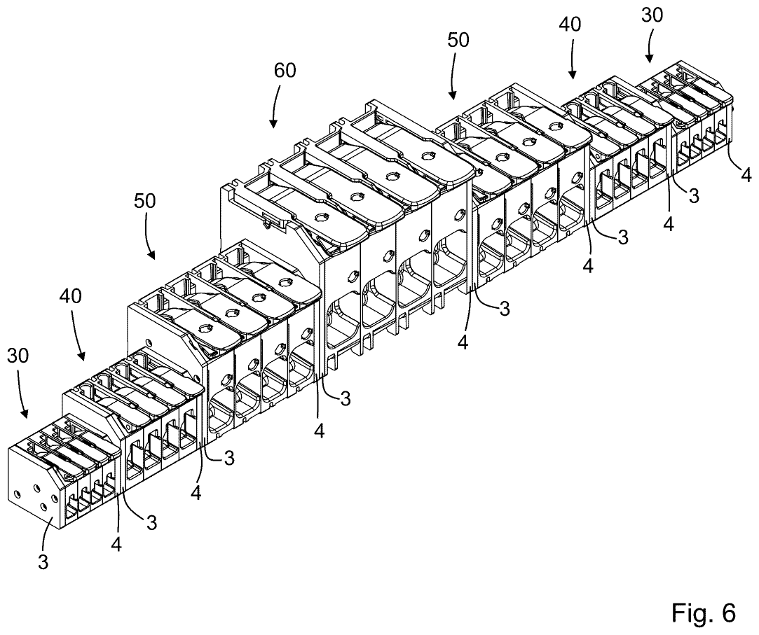

FIG. 6 shows an example of a conductor terminal block in which, viewed from the left, conductor terminals 30 of the first size are arranged first, then conductor terminals 40 of a second size, then conductor terminals 50 of the third size, then conductor terminals 60 of the fourth size, then again conductor terminals 50 of the third size, then conductor terminals 40 of the second size, and finally at the end again conductor terminals 30 of the first size. Two adapter plates which are plugged together are again located between the conductor terminals of different sizes; i.e. a right-sided adapter plate 4 is plugged together with a left-sided adapter plate 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A set comprising:
at least two adapter plates to connect conductor terminals of different sizes, each of the at least two adapter plates have a plate-shaped base body with a first connection side and a second connection side facing away from the first connection side,
first connecting elements provided on the base body on the first connection side, the first connecting elements configured to be connected to connecting elements of a conductor terminal, the connecting elements being designed as counterparts to the first connecting elements,
second connecting elements provided on the base body on the second connection side, the second connecting elements configured to be connected to second connecting elements of an adjacent adapter plate, the second connecting elements being designed as counterparts; and
at least two adapter plates with base bodies of different sizes, a size of the base bodies being adapted to a size of a conductor terminal to be connected to the first connection side of the adapter plate.

2. The set according to claim 1, wherein the adapter plates with differently sized base bodies each have connection-compatible second connecting elements on their second connection sides so that conductor terminals of different sizes are adapted to be connected to one another via adapter plates with differently sized base bodies, and wherein the conductor terminals of different sizes are connected to one another via the second connecting elements on the second connection sides of adjacent adapter plates.

3. The set according to claim 1, wherein the set for the conductor terminals of different sizes each has a left-sided adapter plate, which is adapted to be connected with its first connection side to a left housing side of the conductor terminal, and a right-sided adapter plate, which is adapted to be connected with its first connection side to the right housing side of the conductor terminal.

4. The set according to claim 1, wherein the first connecting elements and/or the second connecting elements are designed as positive-locking connecting elements or as latching elements.

5. The set according to claim 1, wherein the adapter plates of the set are configured to connect the conductor terminals to one another in identical spatial alignment of their conductor connection side.

6. The set according to claim 1, wherein the adapter plate has a plate-shaped base body with a first connection side and a second connection side facing away from the first connection side, wherein, on the first connection side, the base body has first connecting elements that are configured to be connected to connecting components of a conductor terminal, the components being designed as counterparts to the first connecting elements, and wherein on the second connection side the base body has second connecting elements, which are configured to be connected to second connecting elements of an adjacent adapter plate, the elements being designed as counterparts.

7. A conductor terminal block, which is modularly constructed from individual conductor terminals and adapter plates of a set according to claim 1, the conductor terminal block comprising:
at least two conductor terminals of different sizes,
wherein a first adapter plate is connected with its first connection side to at least one conductor terminal of a first size and a second adapter plate is connected with its first connection side to at least one adjacent conductor terminal of a second size, which differs from the first size, and
wherein the first and second adapter plates are connected to one another via their respective second connection sides.

8. The conductor terminal block according to claim 7, wherein a plurality of conductor terminals of the same size are connected directly immediately adjacent to one another without an adapter plate being arranged therebetween.

9. The conductor terminal block according to claim 7, wherein at least one conductor terminal has a housing which has an open housing side on one side, and wherein the open housing side is covered by an end plate attached to the housing or an adapter plate.

10. The conductor terminal block according to claim 9, wherein an adapter plate is attached with its first connection side to the end plate.
